(19) United States
(12) Patent Application Publication
(10) Pub. No.: US 2006/0130886 A1
(43) Pub. Date: Jun. 22, 2006

(54) Method and apparatus for manufacturing cleaning material and cleaning system using the same

(75) Inventors: Masuo Tada, Tokyo (JP); Takahiko Hiroi, Tokyo (JP); Takeshi Tanaka, Tokyo (JP)

Correspondence Address: Koda & Androlia, Suite 1140, 2029 Century Park East, Los Angeles, CA, 90067-2983, US

(73) Assignee: Taiyo Nippon Sanso Corporation

(21) Appl. No.: 11/021,177

(22) Filed: Dec. 22, 2004

(51) Int. Cl. B08B 3/00

(52) U.S. Cl. 134/198

(57) ABSTRACT

A cleaning material for cleaning, for instance, a substrate by being sprayed onto and colliding with the substrate being in a sherbet-form (in which a solid and liquid are co-present) that contains ice particles and being manufactured by cooling a mixed liquid, which comprises pure water and an organic compound liquid having a solidification point lower than that of pure water, to a supercooled state, and generating ice crystals by applying an external force to supercooled liquid which consists of the cooled mixed liquid. The application of the external force to the supercooled liquid is accomplished by, for example, an abruptly expanded portion formed in a flow passage for the supercooled liquid. When the supercooled liquid flows into the abruptly expanded portion, a swirling stream is generated that dissolves the supercooled state of the supercooled liquid, thus solidifying the water in the supercooled liquid to form ice particles.

### BACKGROUND OF THE INVENTION

1. Technical Field

The present invention relates to a method and apparatus for manufacturing a cleaning material that can suitably be used in cases where fine contaminants (fine particles and the like constituting sources of substrate contamination; hereafter referred to as “particles”) adhering to various types of substrates (e.g., semiconductor wafers, electronic device substrates, liquid crystal substrates, photo-masks, glass substrates, or the like) are to be cleaned or removed and further to a cleaning system that uses method and apparatus.

2. Description of the Related Art

For example, the cleaning of substrates such as semiconductor wafers is generally accomplished by brush scrubbers that remove particles adhering to the substrate by rubbing the surface of the substrate by means of a brush using mohair, nylon or the like with a bristle diameter of 100 to 300 μm. However, in the cleaning of substrates by such brush scrubbers, the brush is pressed against the surface of the substrate while being rotated, and foreign matter is scrubbed away by the resulting frictional force. Consequently, particles that are fine particles and constitute a source of substrate contamination are generated and re-adhere to the substrate as a result of rubbing of the brush against each other and rubbing against step differences in the substrate wiring, resulting in that the substrate cleaning effect is lowered.

Therefore, ice scrubbers, which are devised so that substrates are cleaned by spraying fine ice particles as a cleaning agent onto the substrates or causing these particles to collide with the substrates, using a carrier gas, have been recently proposed. Such ice scrubbers rinse the substrates and thus make it possible to perform substrate cleaning effectively without any generation or re-adhesion of particles.

However, when cleaning substrates by ice scrubbers, since the cleaning material consists of hard ice particles, and since these particles are caused to collide with the substrate at a high speed by means of a gas (carrier gas), there is a danger that the substrate is damaged as a result of such collision of the cleaning material.

Furthermore, since the ice particles are scattered after the collision with the substrate, and since the removed contaminant particles fly over the periphery of the substrate, there is a danger that the substrate will be re-contaminated.

In order to prevent such flight of the contaminant particles, it is necessary to rinse the substrate with pure water or the like together with the spraying of the ice particles. However, in such rinsing, the ice particles are melted by the rinse water, and effective utilization of cooling and heating is not achieved. In addition, the problem of increased running costs arises. Furthermore, the problem of extremely poor handling characteristics also arises, such as clogging of the transport piping due to the formation of lumps of ice as a result of the ice particles melting together and the like.

### BRIEF SUMMARY OF THE INVENTION

The object of the present invention is to provide a method and apparatus for manufacturing a cleaning material that favorably and effectively cleans a cleaning object member such as substrates without causing problems such as those encountered in the above-described ice scrubbers in cases where the cleaning material is thus sprayed or caused to collide with the cleaning object member such as a substrate and to provide a cleaning system.

The above object is accomplished by unique steps of the present invention for a method for manufacturing a cleaning material which is used to clean a cleaning object member such as substrates by being sprayed onto these members or being caused to collide with these members; and in the present invention, a mixed liquid that comprises water and an organic compound liquid having a solidification point lower than that of water is cooled to a supercooled state, and ice crystals are generated by applying an external force to the resulting supercooled liquid comprising the cooled mixed liquid, thus producing a sherbet-form cleaning material in which a solid and liquid are co-present and which contains ice particles.

Generally, when the temperature of water drops, the kinetic energy of the water molecules decreases. Meanwhile, energy (energy of activation) is required in order to generate ice nuclei (ice crystals). Accordingly, a state in which no ice crystals are formed may be produced in some cases even when the temperature drops below the freezing point, due to the fact that the kinetic energy of the water molecules decreases and a sufficient energy cannot be obtained. Such a state is called a “supercooled state” which is an extremely unstable state in terms of thermodynamics; and this supercooling is eliminated by the application of even a very slight external force (shock, vibration, or the like), thus generating ice crystals.

The cleaning material manufacturing method of the present invention utilizes such a supercooling phenomenon to produce the above-described sherbet-form cleaning material.

In practicing such a manufacturing method, it is generally desirable to use pure water as the raw-material water.

Furthermore, an organic compound liquid that has no deleterious effects on the cleaning object member (surface that is the object of cleaning) such as a substrate is used as the organic compound liquid; and in concrete terms, for example, isopropyl alcohol, methyl alcohol, ethyl alcohol, acetone, or mixtures of two or more of these compounds are used. Generally, nonetheless, it is desirable to use isopropyl alcohol.

Moreover, it is desirable that the concentration of the organic compound liquid in the cleaning material or raw material (mixed liquid) (i.e., the proportion of the mass of the content of the organic compound liquid relative to the total mass of the cleaning material or raw material) be in the range of 1 mass % to 80 mass %. More specifically, if the concentration of the organic compound liquid is less than 1 mass %, the diameter of the ice particles becomes excessive, and it becomes difficult to control the freezing temperature. Conversely, if the concentration of the organic compound liquid exceeds 80 mass %, the temperature at which the water component in the raw material freezes (the solidification point) drops greatly, so that an excessively large amount of energy is required in order to manufacture the cleaning material. Furthermore, even if all of the water component in the raw material is frozen, the ice concentration is reduced to an extent greater than necessary, so that the cleaning power (blast effect) of the cleaning material drops, and the energy efficiency is also extremely poor.

In addition, it is desirable that the concentration of the ice particles in the cleaning material (i.e., the proportion of the mass of the ice particle content relative to the total mass of the cleaning material or raw material; hereafter referred to as the “ice concentration”) be in the range of 0.2 mass % to 99 mass %. More specifically, if the ice concentration is less than 0.2 mass %, the cleaning effect of the cleaning material is not sufficiently manifested; conversely, if the ice concentration exceeds 99 mass %, then the fluidity of the cleaning material drops, and transportation of the cleaning material becomes difficult.

The ice concentration is set in accordance with cleaning conditions such as the properties of the surface that is the object of cleaning and the degree of contamination; generally, however, the ice concentration is set at a high value in cases where a strong blast by the ice particles (a type of ice blast) is required, and it is conversely set at a low value in cases where there is no great requirement for such a strong blast.

The above object is further accomplished by a unique structure of the present invention for an apparatus for manufacturing a cleaning material which is used to clean a cleaning object member by being sprayed onto these members or caused to collide with these members; and in the present invention, the cleaning material manufacturing apparatus comprises a liquid feeding passage which causes a mixed liquid comprising water and an organic compound liquid having a solidification point lower than that of water to flow from a reservoir tank to a predetermined cleaning material use section, a cooling mechanism which cools the mixed liquid flowing through the liquid feeding passage to a supercooled state, and a supercooling release mechanism which causes ice crystals to be generated by applying an external force to the supercooled liquid flowing through the portion of the liquid feeding passage located on the downstream side of the cooling mechanism, this supercooled liquid being a mixed liquid that has been cooled to a supercooled state; and in this structure, a sherbet-form cleaning material in which a solid and liquid are co-present and which contains ice crystals is obtained by causing the mixed liquid flowing through the liquid feeding passage to pass through the cooling mechanism and supercooling release mechanism.

In the above structure, it is preferable that the cooling mechanism be comprised of a heat exchange chamber, in which a cooling medium is circulated between this chamber and a cooling chamber, and a heat exchange passage, which is a part of the liquid feeding passage that passes through the heat exchange chamber and whose peripheral walls are constructed by heat-transferring walls; and the mixed liquid is cooled to a supercooled state by heat exchange with the cooling medium while this mixed liquid passes through the heat exchange passage.

It is further preferable that supercooling release mechanism be formed with a swirling stream generating section in the portion of the liquid feeding passage located on the downstream side of the cooling mechanism so that the cross-sectional area of the swirling stream generating section or of this portion of the liquid feeding passage expands abruptly in the direction of flow of the supercooled liquid, and this supercooling release mechanism be constructed so that an external force is applied to the supercooled liquid by the swirling stream generated as a result of the supercooled liquid flowing into the swirling stream generating section, thus generating ice crystals.

Alternatively, the supercooling release mechanism can be constructed so that a gas jet nozzle and an ultrasonic transmitter are disposed in the portion of the liquid feeding passage that is located on the downstream side of the cooling mechanism, and so that an external force is applied so as to generate ice crystals by generating ultrasonic waves while causing a water saturated gas or dry gas to jet from the gas jet nozzle into the supercooled liquid flowing through the above-described portion of the liquid feeding passage. In this case, the gas is caused to jet from the gas jet nozzle in the direction of flow of the supercooled liquid, in a direction that is perpendicular to this direction of flow, or in the direction that is the opposite of the direction of flow of the supercooled liquid.

The above object is further accomplished by a unique structure of the present invention for a cleaning system which comprises a cleaning material manufacturing apparatus constructed as described above, and a cleaning material spraying apparatus which is connected to a part of the liquid feeding passage that is located on the downstream side of the supercooling release mechanism and which sprays the cleaning material toward the cleaning object member from this portion of the liquid feeding passage.

In this cleaning system of the present invention, it is desirable to construct the cleaning material spraying apparatus so that the cleaning material spraying apparatus comprise a cleaning material spraying device (e.g., a spray gun) that accelerates the cleaning material by means of a carrier gas and sprays the cleaning material onto the cleaning object member.

Furthermore, it is desirable that the cleaning material that flows through the portion of the liquid feeding passage that is located on the downstream side of the supercooling release mechanism be maintained at a temperature of 0° C. to −50° C. More specifically, the cleaning material is maintained in a temperature range extending from a temperature that is equal to or lower than the solidification point of water (equal to or lower than the freezing point) to a temperature that is higher than the solidification point of the organic compound liquid that is used. The reason for this is that if the cleaning material used is at a temperature lower than −50° C., the viscosity of the organic compound liquid such as isopropyl alcohol (IPA) increases to a high viscosity, which causes a danger that the cleaning material cannot be handled smoothly in terms of pressure feeding into the cleaning material spraying device, etc.

### BRIEF DESCRIPTION OF THE SEVERAL VIEWS OF THE DRAWINGS

FIG. 1 is a system diagram that shows an embodiment of the cleaning system of the present invention;

FIG. 2 is a longitudinally sectional side view of one example of the supercooling release mechanism;

FIGS. 3(A), 3(B) and 3(C) are longitudinally sectional side views of the modified examples of the supercooling release mechanism; and

FIG. 4 is a diagram which shows still another modified example of the supercooling release mechanism.

### DETAILED DESCRIPTION OF THE INVENTION

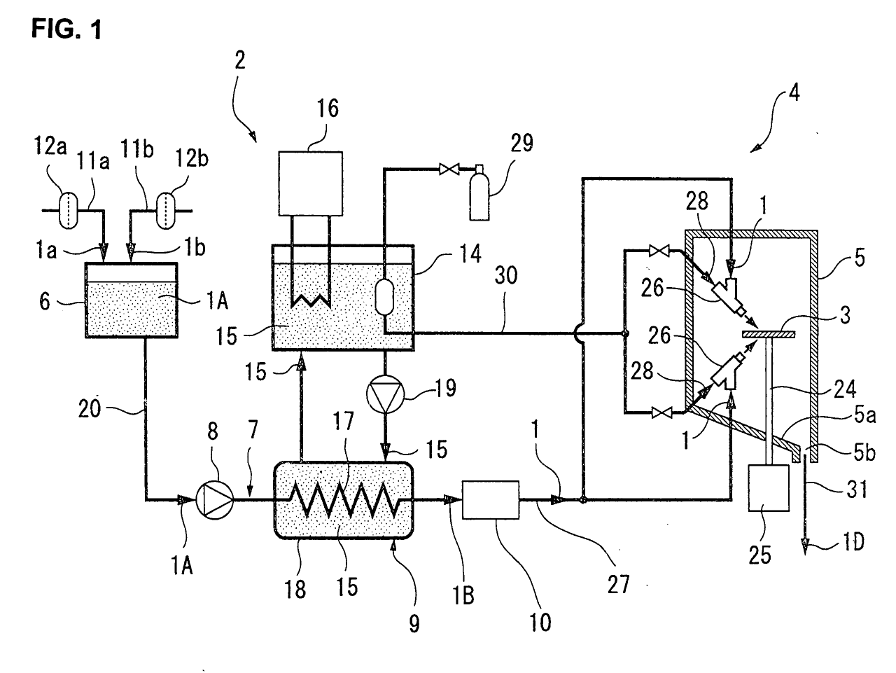

Below, the construction of the present invention will be concretely described on the basis of the embodiment shown in FIGS. 1 through 4.

This embodiment relates to an example in which the present invention is applied to a cleaning system that cleans (or remove) particles adhering to a substrate (i.e., particles adhering to the substrate such as a semiconductor wafer, electronic device substrate, liquid crystal substrate, photo-mask and glass substrate) by spraying the cleaning material onto the substrate or causing the cleaning material to collide with the substrate in the same manner as an ice scrubber.

More specifically, as shown in FIG. 1, the cleaning system of this embodiment comprises a cleaning material manufacturing apparatus 2, which manufactures a sherbet-form cleaning material 1, and a cleaning material spraying apparatus 4, which sprays the cleaning material 1 toward the member 3 that is the object of cleaning (object to be cleaned).

As shown in FIG. 1, the cleaning material manufacturing apparatus 2 is comprised of a storage tank 6 (buffer tank) constituting a reservoir section that stores a mixed liquid 1A (raw material of the cleaning material 1) comprising raw-material water 1a and an organic compound liquid 1b which has a lower solidification point than water, a liquid feeding passage 7 that leads from the storage tank 6 to a cleaning material use section 4 (cleaning material spraying apparatus), a liquid feeding pump 8 that is disposed in the liquid feeding passage 7, a cooling mechanism 9 and a supercooling release mechanism 10. In this example, pure water is used as the water 1a that constitutes a part of the mixed liquid 1A, and isopropyl alcohol (mp=−89.5° C., bp=82.4° C.) is used as the organic compound liquid 1b. Isopropyl alcohol 1b is a compound that is generally used as a cleaning liquid for semiconductor wafers and the like and has no deleterious effects on substrates 3 such as semiconductor wafers.

The pure water 1a and isopropyl alcohol 1b are supplied to the storage tank 6 from respective separate supply passages 11a and 11b. Filters 12a and 12b are disposed in the respective supply passages 11a and 11b so that even in cases where particles are contained in the respective liquids 1a and 1b, these respective liquids 1a and 1b are supplied to the storage tank 6 after these particles are removed by the filters 12a and 12b. The amounts of pure water 1a and isopropyl alcohol 1b that are supplied to the storage tank 6 are set so that the concentration of isopropyl alcohol 1b (hereafter referred to as the “IPA concentration”) in the mixed liquid 1A inside the storage tank 6 is 1 mass % to 80 mass %.

As shown in FIG. 1, the cooling mechanism 9 comprises a cooling chamber 14, a freezer 16 that cools a cooling medium 15 inside the cooling chamber 14, a heat exchange passage 17 that constitutes a part of the liquid feeding passage 7, a heat exchange chamber 18 which surrounds the heat exchange passage 17 and is filled with the cooling medium 15, and a cooling medium flow pump 19 which causes circulating flow of the cooling medium 15 between the cooling chamber 14 and the heat exchange chamber 18.

Meanwhile, as shown in FIG. 1, the liquid feeding pump 8 is disposed in the liquid feeding passage 20 that connects the entry portion of the heat exchange passage 17 (which is the portion of the liquid feeding passage that passes through the heat exchange chamber 18) and the bottom part of the storage tank 6; and this pump 8 supplies a fixed amount of the raw-material mixed liquid 1A to the heat exchange passage 17 from the storage tank 6.

The peripheral walls of the heat exchange passage 17 are formed by heat transfer walls, so that the mixed liquid 1A is supercooled by heat exchange with the cooling medium 15 inside the heat exchange chamber 18 while the mixed liquid 1A is passing through the heat exchange passage 17. More specifically, the mixed liquid 1A is cooled by controlling the temperature to which the cooling medium 15 is cooled by the freezer 16, the transport velocity (flow velocity) of the mixed liquid 1A determined by the liquid feeding pump 8, and the like so that the mixed liquid 1A assumes a supercooled state, which is a temperature state lower than the solidification point of the water 1b but higher than the solidification temperature of the IPA, in which the water 1b does not freeze (i.e., in which ice nuclei are not generated).

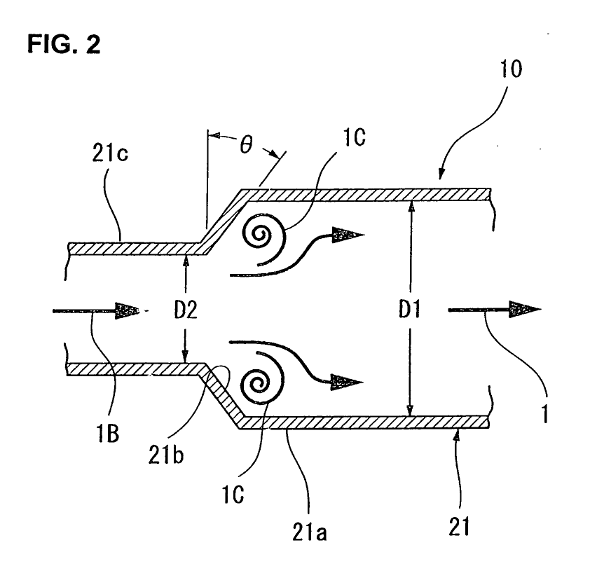

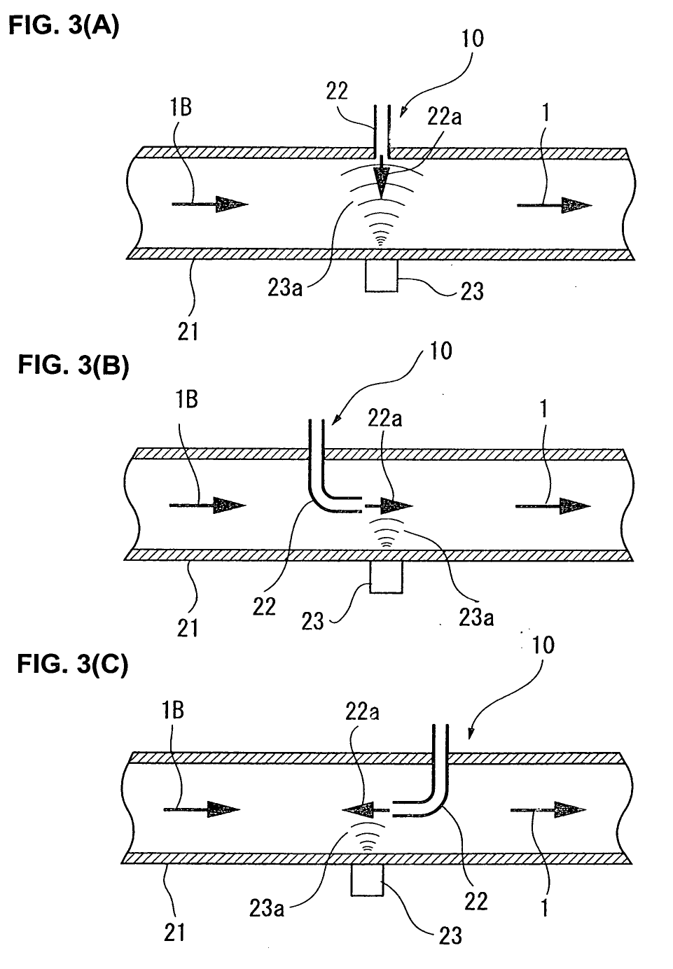

As shown in FIG. 1, the supercooling release mechanism 10 is designed so that it generates ice crystals (ice nuclei) by applying an external force to the supercooled liquid 1B which is the mixed liquid that has been cooled to a supercooled state and has flowed into the external force application passage 21, which is a part of the liquid feeding passage that is connected to the exit portion of the heat exchange passage 17, from the heat exchange passage 17. The supercooling release mechanism 10 is constructed as shown in, for example, FIG. 2 or FIG. 3.

The supercooling release mechanism 10 shown in FIG. 2 has the external force application passage 21 that is formed with a swirling stream generating section 21 a so that the cross-sectional area of this external force application passage expands abruptly in the direction of flow of the supercooled liquid 1B, thus causing a swirling stream 1C to be generated in the supercooled liquid 1B that flows into the external force application passage 21 from the heat exchange passage 17 by the abrupt expanded portion of the flow passage in the swirling stream generating section 21a.

The supercooled state of the supercooled liquid 1B is dissolved by the external, force (agitating force) that is applied by this swirling stream 1C, so that all or part of the water content in the supercooled liquid 1B solidifies and forms ice particles, thus producing a sherbet-form cleaning material 1 (in which a solid and liquid are co-present) containing ice particles. More specifically, the supercooled liquid 1B flowing through the external force application passage 21 in a laminar flow state from the heat exchange passage 17 is caused to assume a state of turbulent flow by the swirling stream 1C in the swirling stream generating section 21a, so that the supercooled state is dissolved, and ice crystals are generated. These ice particles gradually grow while flowing through the swirling stream generating section 21a. Furthermore, some of the ice crystals adhere to the entry wall surface 21b of the swirling stream generating section 21a and grow; however, these adhering particles are stripped from the entry wall surface 21b by the swirling stream 1C. As a result of the generation, growth and stripping of such ice particles, a sherbet-form cleaning material 1 that contains ice particles is obtained in the swirling stream generating section 21a.

The ice density (ice concentration) in the cleaning material 1 thus obtained varies according to the degree of generation of ice particles in the entry portion of the swirling stream generating section 21a and the degree of growth and stripping of the ice particles on the entry wall surface 21b. Here, the degree of generation of the ice particles is affected by the degree of expansion in the external force application passage 21, i.e., the diameter difference ΔD (=D1−D2) between the diameter D1 of the swirling stream generating section 21a and the diameter D2 of the portion 21c on the upstream side of this swirling stream generating section (i.e., the portion that connects with the heat exchange passage 17) and the degree of stripping of the ice particles on the entry wall surface 21b is affected by the amount of taper (i.e., the angle of inclination with respect to the direction of flow of the supercooled liquid 1B) θ of the entry wall surface 21b. More specifically, the diameter difference ΔD and taper amount θ are determined in ranges that make it possible to generated the swirling stream 1C; the quantity of ice particles generated increases as the diameter difference ΔD is increased, and the strippability of the ice particles increases as the taper amount θ is increased. Accordingly, the ice concentration of the cleaning material 1 can be controlled by appropriately setting the diameter difference ΔD and the taper amount θ in accordance with the supercooling conditions such as the supercooling temperature and the flow velocity of the supercooled liquid. Generally, it is desirable that the ice concentration be controlled to a value of 0.2 mass % to 99 mass % as described above.

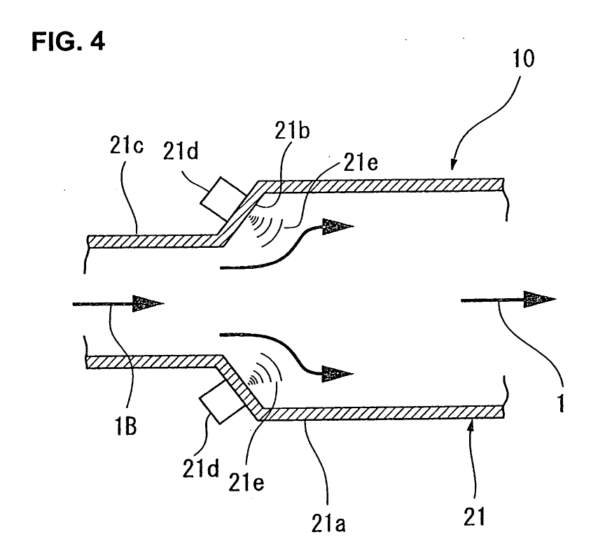

In the above-described supercooling release mechanism 10, it is also effective to design it so that the stripping of adhering particles from the entry wall surface 21b and the like are promoted with an ultrasonic transmitter 21d installed in the swirling stream generating section 21a as shown in FIG. 4 so that ultrasonic waves (e.g., with a frequency of approximately 28 kHz) 21e to act on these particles.

In the supercooling release mechanism 10 shown in FIG. 3, a gas jet nozzle 22 and an ultrasonic transmitter 23 are installed in the external force application passage 21; and by way of blowing a gas 22a from the nozzle 22 into the supercooled liquid 1B that flows through the external force application passage 21, thus generating gas bubbles, and by way of causing ultrasonic waves (e.g., with a frequency of approximately 28 kHz) 23a to act on the supercooled liquid, the supercooled state of the supercooled liquid 1B is dissolved and ice particles are generated, thus producing a sherbet-form cleaning material 1. The ice concentration of the cleaning material 1 that is obtained can be controlled by appropriately setting the amount of gas that is blown in from the gas jet nozzle 22, the intensity of the ultrasonic waves, and the like in accordance with the supercooling conditions such as the supercooling temperature and the flow velocity of the supercooled liquid. Generally, it is desirable to control this ice concentration to a value of 0.2 mass % to 99 mass % as described above.

Besides blowing in the gas 22a in a direction perpendicular to the direction of flow of the supercooled liquid 1B as shown in FIG. 3(A), it would also be possible to blow in the gas 22a in the same direction as this direction of flow as shown in FIG. 3(B), or to blow in the gas 22a in the opposite direction from the above-described direction of flow as shown in FIG. 3(C).

It is desirable to use a clean dry gas or water-saturated gas as the gas 22a. Generally, a gas that is inert with respect to the cleaning material 1 and the member 3 that is the object of cleaning (i.e., a gas that has no deleterious effect), such as nitrogen gas, is used. In the shown example, nitrogen gas that is pre-cooled to a temperature of approximately 1 to 3° C. is used. It is also desirable that the gas 22a be pre-cooled.

As seen from the above, a sherbet-form cleaning material 1 containing ice particles (in which a solid and liquid are co-present) is obtained by applying with the supercooling release mechanism 10 an external force to the mixed liquid (i.e., a supercooled liquid 1B) that has been placed in a supercooled state by the cooling mechanism 9. The cleaning material 1 is supplied to the cleaning material spraying apparatus 4 from a cleaning material supply passage 27 of the liquid feeding passage 7 and is sprayed onto a substrate 3 inside a cleaning treatment chamber 5 by this cleaning material spraying apparatus 4.

In the cleaning treatment chamber 5, as shown in FIG. 1, the bottom part 5a is constructed as an inclined surface that is inclined downward toward a cleaning residue discharge port 5b that is disposed in this bottom part. The cleaning treatment chamber 5 comprises a supporting shaft 24, on which the central portion of the undersurface of the substrate 3 (such as a semiconductor wafer) is placed and which supports this substrate 3 so that the substrate is free to rotate horizontally inside the chamber 5, and a driving source 25 (motor or the like), which rotationally drives this supporting shaft 24.

As shown in FIG. 1, the cleaning material spraying apparatus 4 comprises a pair of cleaning material sprayers 26 which are disposed inside the cleaning treatment chamber 5 in a state in which the nozzle openings face the front and back surfaces, which are to be cleaned, of the substrate 3 (that is the object to be cleaned).

The respective cleaning material sprayers 26 are spray guns which are connected to a part of the liquid feeding passage 27 (cleaning material supply passage connected to the external force application passage 21) located on the downstream side of the supercooling release mechanism 10 and which accelerate the cleaning material 1 supplied from the cleaning material supply passage 27 by means of a carrier gas 28 (nitrogen gas in this example) at a predetermined pressure, and thus spray the cleaning material 1. More specifically, a three-phase mixed fluid comprising a solid (ice particles), liquid (isopropyl alcohol 1b or isopropyl alcohol 1b and pure water 1a) and gas (carrier gas 28) is sprayed from the respective spray guns 26 at a predetermined angle onto the front and back surfaces of the substrate 3 and is thus caused to collide with these front and back surfaces.

The carrier gas 28 is supplied to the respective spray guns 26 from a carrier gas supply source 29 (gas tank) via carrier gas supply passages 30; and it is designed so that portions of the carrier gas supply passages 30 are provided so as to pass through the above-described cooling chamber 14 so that the carrier gas 28 is supplied to the spray guns 26 after being pre-cooled by the cooling medium 15. Moreover, the cleaning material supply passage 27 has an appropriate adiabatic or cold-retaining structure so that the cleaning material 1 that is supplied to the spray guns 26 is maintained at a temperature of 0° C. to −50° C.

Incidentally, the cleaning residue 1D that flows downward through the bottom part 5a of the cleaning treatment chamber 5 and is discharged from the cleaning residue discharge port 5b can be recovered in the storage tank 6 from a cleaning residue recovery passage 31 via a filter or the like after being liquefied by a heat exchanger. This heat exchanger melts (thaws) the ice particles contained in the cleaning residue 1D by heat exchange with a heating medium. Here, a fluid used in the above-described cleaning system (cooling water used in the freezer 16, gas 22a used in the supercooling release mechanism 10, or the like) can be utilized as the heating medium; and with this arrangement, the heat exchanger can be effectively utilized as a pre-cooling means for the above-described fluid.

In the cleaning system constructed as described above, substrate cleaning can be performed very favorably and effectively by accelerating a sherbet-form cleaning material 1 (in which a solid and liquid are co-present) by means of a carrier gas 28 and by spraying this cleaning material 1 onto the front and back surfaces of the substrate 3 from spray guns 26 so that this cleaning material 1 is caused to collide with the front and back surfaces. More specifically, unlike the cases in which only a solid (ice particles) is accelerated by a carrier gas and caused to collide with the substrate as in the ice scrubber described at the beginning, in the present invention, a sherbet-form cleaning material 1 in which a solid (ice particles) and a liquid are co-present is caused to collide with the substrate 3; accordingly, the shock that is applied to the front and back surfaces of the substrate 3 by the collision of the ice particles is alleviated by the unfrozen liquid. In other words, the liquid (isopropyl alcohol 1b) which has a higher viscosity than the gas (carrier gas) functions as a liquid film shock absorbing material during the collision of the ice particles.

Furthermore, the ice particles contained in the cleaning material 1 are soft compared to the ice particles used in an ice scrubber, and the properties of the ice particles themselves can also be adjusted by means of the IPA concentration; consequently, an extremely favorable cleaning capacity can be manifested even in the case of substrates 3 in which there is a danger that the surface that is the object of cleaning will be damaged by an ice scrubber. Accordingly, the front and back surfaces of the substrate 3 can be favorably cleaned while securely preventing damage to the substrate 3 caused by the collision of the cleaning material 1.

In particular, the properties (size, density, ease of melting, and the like) of the ice particles contained in the cleaning material 1 can be controlled by adjusting the IPA concentration, so that optimal cleaning in accordance with the properties of the substrate 3 can be performed.

Furthermore, the ice particles are not scattered after colliding with the substrate 3, and the contaminant particles that are removed by the collision of the ice particles are rinsed away by the liquid contained in the cleaning material 1. Accordingly, there is no danger that the removed contaminant particles will re-contaminate the substrate 3, so that a complete contamination-preventing effect is manifested.

Moreover, since the cleaning material 1 is a low-temperature (0° C. or lower) sherbet-form substance containing ice particles, organic substances such as resist films adhering to the substrate 3 solidify and shrink so that such substances are easily removed. Thus, the cleaning effect further improves.

In addition, since the sherbet-form cleaning material 1 has a low temperature and a low vapor pressure, there is no danger of fire, so that safe substrate cleaning can be performed.

Furthermore, since the cleaning material 1 is a sherbet-form material and is maintained at a low temperature even when the contained ice is melted, disposal from the cleaning system, and the recovery and effective utilization of surplus cold energy can be accomplished by recovering the cleaning residue 1D in the storage tank 6 and the like. Thus, the running costs can be greatly reduced.

Moreover, in cases where a cleaning material is made of ice particles alone as in the ice scrubber mentioned above, there is a danger that the ice particles may melt while being transported through the piping and may therefore adhere to each other and form large lumps so that the transport piping becomes clogged. As a result, it is necessary to ensure a high degree of cold retention in the transport piping of the cleaning material so that the ice particles do not melt. However, in the above-described cleaning material 1 of the present invention, since this material is a sherbet-form material in which a solid and liquid are co-present, there is no danger that the ice particles will adhere to each other and form lumps even if the cold retention means in the transport piping is simple. Accordingly, there is no blockage or the like of the transport piping (liquid feeding passage 7), thus being extremely superior in terms of handling characteristics.

The construction of the cleaning material manufacturing apparatus 2, cleaning material spraying apparatus 4, cleaning treatment chamber 5 and the like can be appropriately modified or altered within limits that involve no departure from the basic principle of the present invention.

More specifically, it is sufficient if the supercooling release mechanism 10 is a mechanism that causes ice crystals to be generated by applying an external force such as a shock or vibration to the supercooled liquid 1B; for example, it would also be possible to use a construction in which a turbulence filter, static mixer, or the like is installed in the external force application passage 21 so that an agitating force or shock force is applied to the supercooled liquid 1B.

It would also be possible to install rinsing equipment using pure water or the like in the cleaning treatment chamber 5 as needed and to install an arrangement in which a recontamination by contaminant particles is prevented even more securely by performing rinsing following the main cleaning treatment by the cleaning material 1.

The removed contaminant particles naturally tend not to re-adhere to the substrate 3 as a result of the contaminant particles being rinsed away by the liquid component contained in the cleaning material 1. However, even if the removed contaminant particles should re-adhere to the substrate, since the adhesive force of these particles is weak, the particles are easily removed by the rinsing.

Moreover, in the second and third cleaning systems, it is indeed possible to arrange so that the cleaning material 1 is blown onto the front and back surfaces of the substrate 3 in the same manner as in the first cleaning system.

Furthermore, a compound that has a lower solidification point than water and that has no deleterious effect on the member that is the object of cleaning or surfaces that are the object of cleaning can be arbitrarily selected as the organic compound liquid 1b in accordance with the cleaning conditions and the like; generally, however, besides the above-described isopropyl alcohol, it is desirable to use methyl alcohol (mp=−97.78° C., bp=64.65° C.), ethyl alcohol (mp=−114.1° C., bp=78.3° C.), acetone (mp=−94.82° C., bp=56.5° C.), or the like.

In addition, besides the above-described cases where substrates 3 such as semiconductor wafers are cleaned, the cleaning system of the present invention can also be suitably applied in general to members constituting the objects of cleaning that are subjected to spray cleaning by means of a liquid, by adjusting the ice concentration in the cleaning material 1, or by altering the spray mode of the cleaning material 1 by means of a cleaning material spray apparatus 4.

As can be easily understood from the above description, according to the method and apparatus of the present invention, a cleaning material, which can favorably and effectively clean the surfaces that are to be cleaned on substrates or the like without causing problems (e.g., secondary contamination of substrates and damage to the elements) that arise in cases where such cleaning is performed using brush scrubbers or ice scrubbers described above, is manufactured efficiently and easily. Furthermore, according to the cleaning system of the present invention, it is possible to reduce the running costs incurred in the cleaning of such substrates or the like and to execute a continuous operation without causing problems such as clogging of the piping.

1. A method for manufacturing a cleaning material that cleans a cleaning object member by being sprayed onto said cleaning object member or being caused to collide with said cleaning object member, said method comprising the steps of:
cooling a mixed liquid, which is comprised of water and an organic compound liquid having a solidification point lower than that of water, to a supercooled state, and
generating ice crystals by applying an external force to the resulting supercooled liquid comprising said cooled mixed liquid, thus
producing a sherbet-form cleaning material in which a solid and liquid are co-present and which contains ice particles.

2. The method for manufacturing a cleaning material according to claim 1, wherein pure water is used as said water.

3. The method for manufacturing a cleaning material according to claim 1 or 2, wherein isopropyl alcohol is used as said organic compound liquid.

4. The method for manufacturing a cleaning material according to claim 1 or 2, wherein a concentration of said organic compound liquid in the mixed liquid is 1 mass % to 80 mass %.

5. The method for manufacturing a cleaning material according to claim 1 or 2, wherein a concentration of ice particles in said cleaning material is 0.2 mass % to 99 mass %.

6. An apparatus for manufacturing a cleaning material that cleans a cleaning object member by being sprayed onto said cleaning object member or being caused to collide with said cleaning object member, said apparatus comprising:
a liquid feeding passage which causes a mixed liquid comprising water and an organic compound liquid having a solidification point lower than that of water to flow from a reservoir tank to a predetermined cleaning material use section,
a cooling mechanism which cools said mixed liquid flowing through said liquid feeding passage to a supercooled state, and
a supercooling release mechanism which causes ice crystals to be generated by applying an external force to a supercooled liquid which is a mixed liquid that has been cooled to a supercooled state and flows through a portion of said liquid feeding passage located on a downstream side of said cooling mechanism; and
wherein a sherbet-form cleaning material, in which a solid and liquid are co-present with ice crystals contained, is obtained by causing said mixed liquid flowing through said liquid feeding passage to pass through said cooling mechanism and supercooling release mechanism.

7. The apparatus for manufacturing a cleaning material according to claim 6, wherein
said cooling mechanism comprises:
a heat exchange chamber in which a cooling medium is circulated between said heat exchange chamber and a cooling chamber, and
a heat exchange passage which is a part of said liquid feeding passage that passes through said heat exchange chamber, peripheral walls of said heat exchange passage being constructed by heat-transferring walls; and wherein
said mixed liquid is cooled to a supercooled state by heat exchange with said cooling medium while said mixed liquid passes through said heat exchange passage.

8. The apparatus for manufacturing a cleaning material according to claim 6 or 7, wherein said supercooling release mechanism is formed with a swirling stream generating section in a portion of said liquid feeding passage located on said downstream side of said cooling mechanism, said swirling stream generating section having a cross-sectional area that expands abruptly in a direction of flow of said the supercooled liquid and applying an external force to said supercooled liquid by a swirling stream generated as a result of said supercooled liquid flowing into said swirling stream generating section, thus generating ice crystals.

9. The apparatus for manufacturing a cleaning material according to claim 6 or 7, wherein said liquid feeding passage is provided with a gas jet nozzle and an ultrasonic transmitter in a portion of said liquid feeding passage that is located on said downstream side of said cooling mechanism, said ultrasonic transmitter generating ultrasonic waves and said gas jet nozzle jetting a water saturated gas or dry gas to said supercooled liquid flowing through said portion of said liquid feeding passage, thus applying an external force that generates ice crystal to said supercooled liquid.

10. A cleaning system comprising:
the apparatus for manufacturing a cleaning material according to claim 6, 7, 8 or 9, and
a cleaning material spraying apparatus which is connected to a part of said liquid feeding passage that is located on a downstream side of said supercooling release mechanism, said cleaning material spraying apparatus spraying a cleaning material toward a member that is an object of cleaning from said portion of said liquid feeding passage.

11. The cleaning system according to claim 10, wherein said cleaning material that flows through said portion of said liquid feeding passage that is located on said downstream side of said supercooling release mechanism is maintained at a temperature of 0° C. to −50° C.

12. The cleaning system according to claim 10 or 11, wherein said cleaning material spraying apparatus comprises a cleaning material spraying device that accelerates said cleaning material by means of a carrier gas and sprays said cleaning material onto said cleaning object member.

13. The method for manufacturing a cleaning material according to claim 3, wherein a concentration of said organic compound liquid in the mixed liquid is 1 mass % to 80 mass

14. The method for manufacturing a cleaning material according to claim 3, wherein a concentration of ice particles in said cleaning material is 0.2 mass % to 99 mass %.

15. The method for manufacturing a cleaning material according to claim 13, wherein a concentration of ice particles in said cleaning material is 0.2 mass % to 99 mass %.
